(19) United States
(12) Patent Application Publication
(10) Pub. No.: US 2006/0029135 A1
(43) Pub. Date: Feb. 9, 2006

(54) In-loop deblocking filter

(76) Inventors: Minhua Zhou, Plano, TX (US); Wai-Ming Lai, Plano, TX (US)

Correspondence Address: TEXAS INSTRUMENTS INCORPORATED, P O BOX 655474, M/S 3999, DALLAS, TX, 75265, US

(21) Appl. No.: 11/158,973

(22) Filed: Jun. 22, 2005

Related U.S. Application Data
(60) Provisional application No. 60/582,355, filed on Jun. 22, 2004.

(51) Int. Cl. H04N 7/12; H04N 11/04; H04B 1/66; H04N 11/02

(52) U.S. Cl. 375/240.12; 375/240.24; 375/240.03; 375/240.18; 375/240.23

(57) ABSTRACT

The in-loop deblocking filter for H.264 video coding has additional buffers for in-place filtering and minimizing memory transfers. One buffer holds a reconstructed macroblock plus columns of the left prior macroblock pixels for vertical edge filtering and plus rows of the top macroblock pixels for horizontal edge filtering; and the other buffer holds the bottom pixel rows of all of the macroblocks of the preceding row of macroblocks.

### CROSS-REFERENCE TO RELATED APPLICATIONS

This application claims priority from provisional application No. 60/582,355, filed Jun. 22, 2004. The following coassigned pending patent applications disclose related subject matter: application Ser. No. 10/375,544, filed Feb. 27, 2003.

### BACKGROUND

The present invention relates to digital video signal processing, and more particularly to devices and methods for video coding.

There are multiple applications for digital video communication and storage, and in response multiple international standards for video coding have been and are continuing to be developed. Low bit rate communications, such as, video telephony and conferencing, led to the H.261 standard with bit rates in multiples of 64 kbps, and the MPEG-1 standard provides picture quality comparable to that of VHS videotape.

H.264/AVC is a recent video coding standard that makes use of several advanced video coding tools to provide better compression performance than existing video coding standards such as MPEG-2, MPEG-4, and H.263. At the core of all of these standards is the hybrid video coding technique of block motion compensation plus transform coding. Block motion compensation is used to remove temporal redundancy between successive images (frames), whereas transform coding is used to remove spatial redundancy within each frame. FIGS. 2a-2b illustrate H.264/AVC functions which include a deblocking filter within the motion compensation loop to limit artifacts created at block edges.

Traditional block motion compensation schemes basically assume that between successive frames an object in a scene undergoes a displacement in the x- and y-directions and these displacements define the components of a motion vector. Thus an object in one frame can be predicted from the object in a prior frame by using the object's motion vector. Block motion compensation simply partitions a frame into blocks and treats each block as an object and then finds its motion vector which locates the most-similar block in the prior frame (motion estimation). This simple assumption works out in a satisfactory fashion in most cases in practice, and thus block motion compensation has become the most widely used technique for temporal redundancy removal in video coding standards

Block motion compensation methods typically decompose a picture into macroblocks where each macroblock contains four 8×8 luminance (Y) blocks plus two 8×8 chrominance (Cb and Cr or U and V) blocks, although other block sizes, such as 4×4, are also used in H.264. The residual (prediction error) block can then be encoded (i.e., transformed, quantized, VLC). The transform of a block converts the pixel values of a block from the spatial domain into a frequency domain for quantization; this takes advantage of decorrelation and energy compaction of transforms such as the two-dimensional discrete cosine transform (DCT) or an integer transform approximating a DCT. For example, in MPEG and H.263, 8×8 blocks of DCT-coefficients are quantized, scanned into a one-dimensional sequence, and coded by using variable length coding (VLC). H.264 uses an integer approximation to a 4×4 DCT.

For predictive coding using block motion compensation, the inverse-quantization and inverse transform are needed for the feedback loop as illustrated in FIG. 2a. The rate-control unit in FIG. 2a is responsible for generating the quantization step (qp) within an allowed range and according to a target bit-rate and buffer-fullness; this controls the transform-coefficients quantization unit. Indeed, a larger quantization step implies more vanishing and/or smaller quantized coefficients which means fewer and/or shorter codewords and consequent smaller bit rates and files.

The in-loop deblocking filter (loop-filter) in H.264 is applied to the reconstructed data to reduce blocking artifacts, typically arising from the block-based transform quantization and the block-based motion compensation. Since each pixel has to be considered individually (adaptive filtering) to determine the amount of filtering needed, the deblocking filtering is a very time consuming task; in fact, the loop-filter process alone takes 30% of the total decoding time. Thus there is a problem slow deblocking filtering.

H.264 clause 8.7 describes the deblocking filtering process. The size of a macroblock in H.264 is 16×16 for the luminance (Y) data and 8×8 for each of the two chrominance (U/V) data. Within a macroblock, the loop-filter is performed in 4×4 blocks for the Y data and in 2×2 blocks for the U/V data. On the upper and left edges of the macroblock, filtering is done between the current macroblock and the upper and left adjacent macroblocks, respectively; see FIG. 5. The exact filtering applied for a pixel depends upon parameters including the boundary filtering strength, bS, at the pixel where bS has values in the range 0, 1, . . . , 4. For Y data filtering and bS=4, the filtering uses 4 pixels to the left or upwards beyond the current edge pixel and 3 pixels to the right or downwards; this is the strongest filtering case. In contrast, for bS=0 there is no filtering, and for bS=1, 2, 3, the filtering uses at most 3 pixels to the left or upwards beyond the current pixel and at most 2 pixels to the right or downwards. Thus the deblocking filtering requires access to (and may modify) the Y data of 4×4 blocks along the boundary of the macroblock to the left and of the macroblock above the macroblock being filtered.

### SUMMARY OF THE INVENTION

The present invention provides buffers for in-loop filtering in block-based motion compensation to minimize memory accesses and thereby speed up the filtering.

### BRIEF DESCRIPTION OF THE DRAWINGS

FIGS. 1a-1e show memory accesses for a preferred embodiment implementation.

FIGS. 2a-2b show H.264 video coding functional blocks.

FIGS. 3a-3b show various hardware structures.

FIG. 4 illustrates network communication.

FIG. 5 shows deblocking filtering edges.

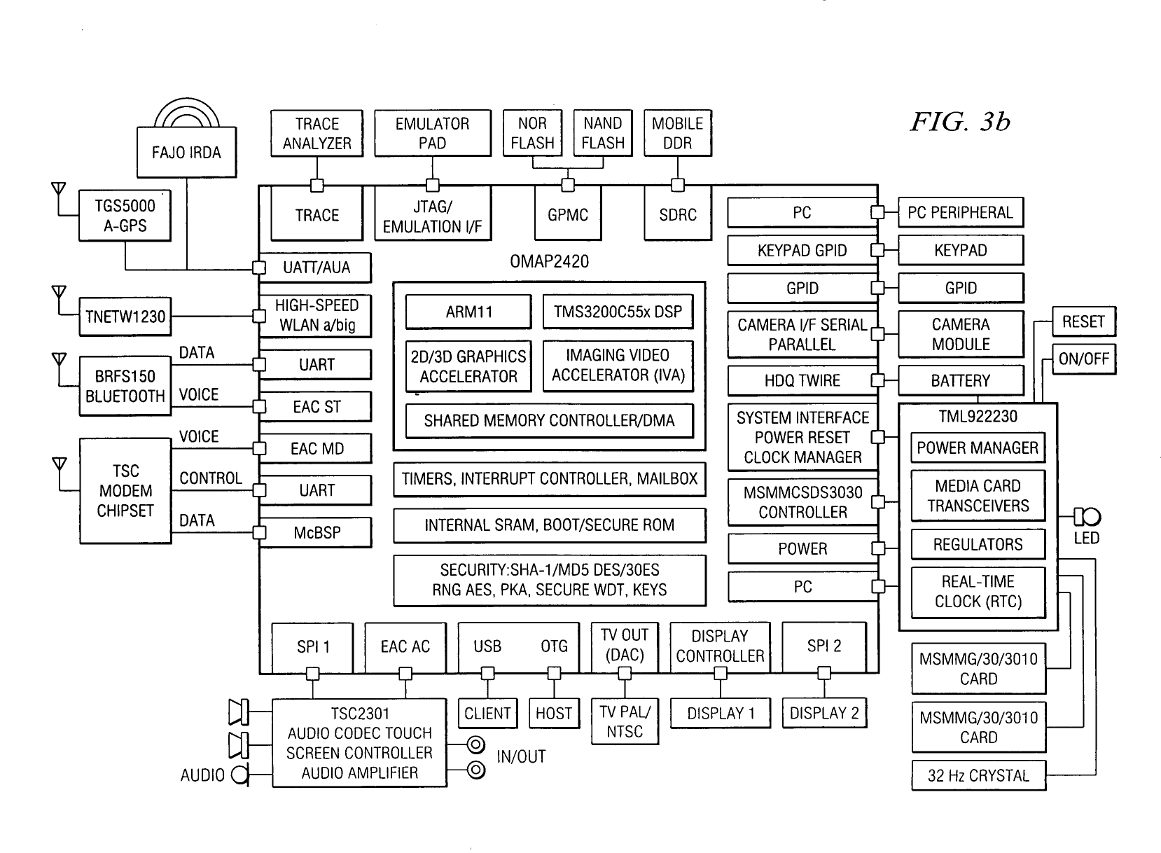

### DESCRIPTION OF THE PREFERRED EMBODIMENTS

1. Overview

Preferred embodiment methods speed up the H.264 loop-filter process by minimizing the amount of memory transfer. In particular, the preferred embodiment methods allocate a 20×20 loop-filter buffer (deblockY) for the Y data and two 10×10 buffers (deblockU and deblockV) for the U/V data. The top 4 rows of deblockY (top 2 rows of deblockU/deblockV) are for data from the upper adjacent macroblock, and the left 4 columns (left 2 columns for U/V data) are for data from the left adjacent macroblock, while the rest of the buffer is for data of the current macroblock. This buffer structure allows simple automatic increment of data pointers inside the loop-filter and eliminates the need of extra storage for the left macroblock data. To further reduce memory usage and data moves, the deblock buffers are made to overlap with the prediction buffers used during macroblock reconstruction. By doing this, the deblock buffers are automatically filled with the reconstructed data at the end of each macroblock decoding, and data copy from the prediction buffers to the deblock buffers is avoided.

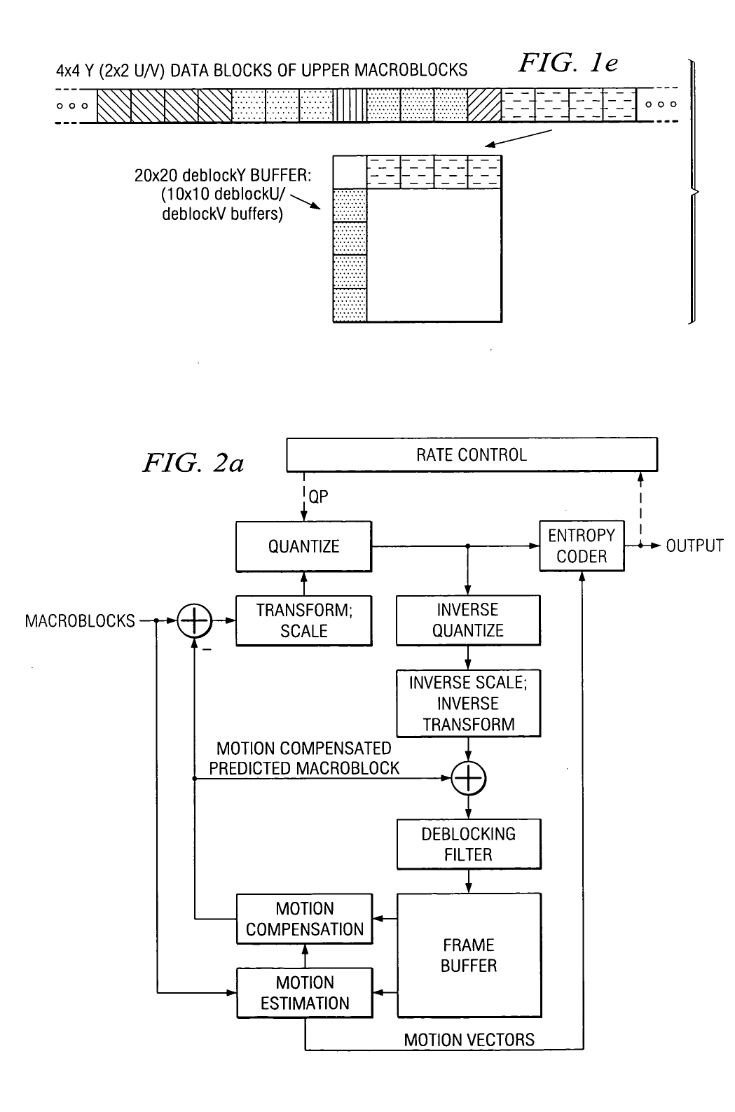

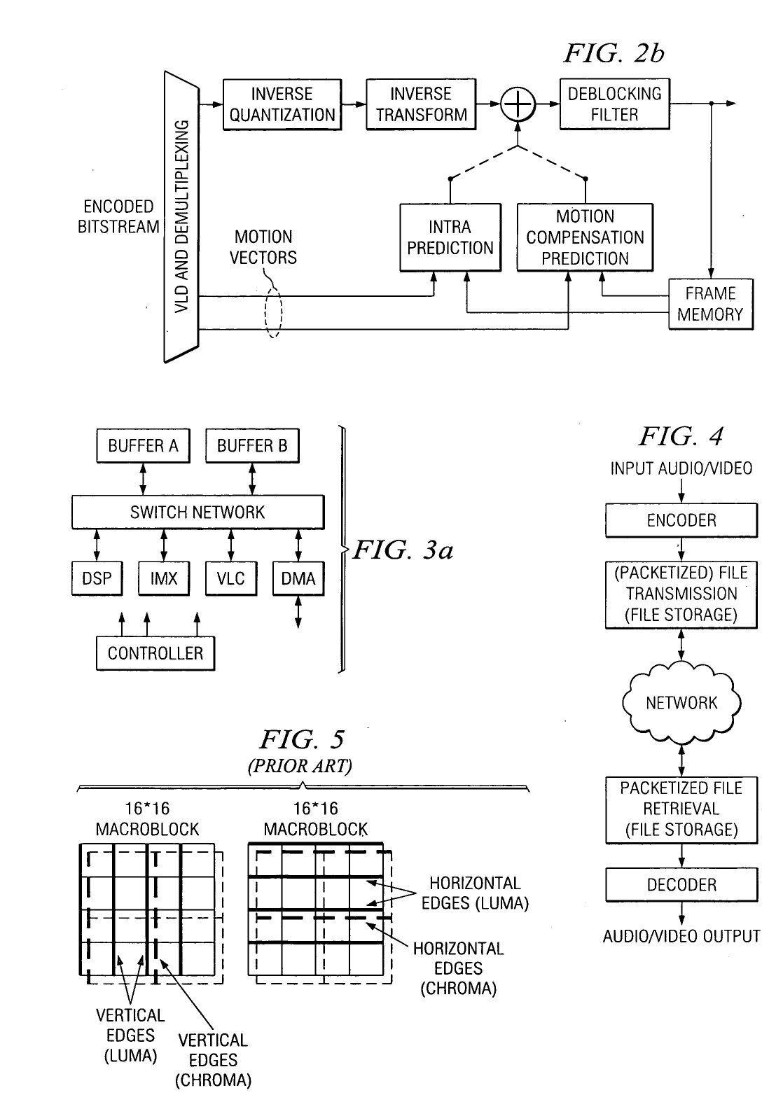

Preferred embodiment systems (e.g., cellphones, PDAs, digital cameras, notebook computers, etc.) perform preferred embodiment methods with any of several types of hardware: digital signal processors (DSPs), general purpose programmable processors, application specific circuits, or systems on a chip (SoC) such as multicore processor arrays or combinations of a DSP and a RISC processor together with various specialized programmable accelerators (e.g., FIGS. 3a-3b). A stored program in an onboard or external (flash EEP)ROM or FRAM could implement the signal processing. Analog-to-digital and digital-to-analog converters can provide coupling to the analog world; modulators and demodulators (plus antennas for air interfaces) can provide coupling for transmission waveforms; and packetizers can provide formats for transmission over networks such as the Internet as illustrated in FIG. 4.

2. First Preferred Embodiment

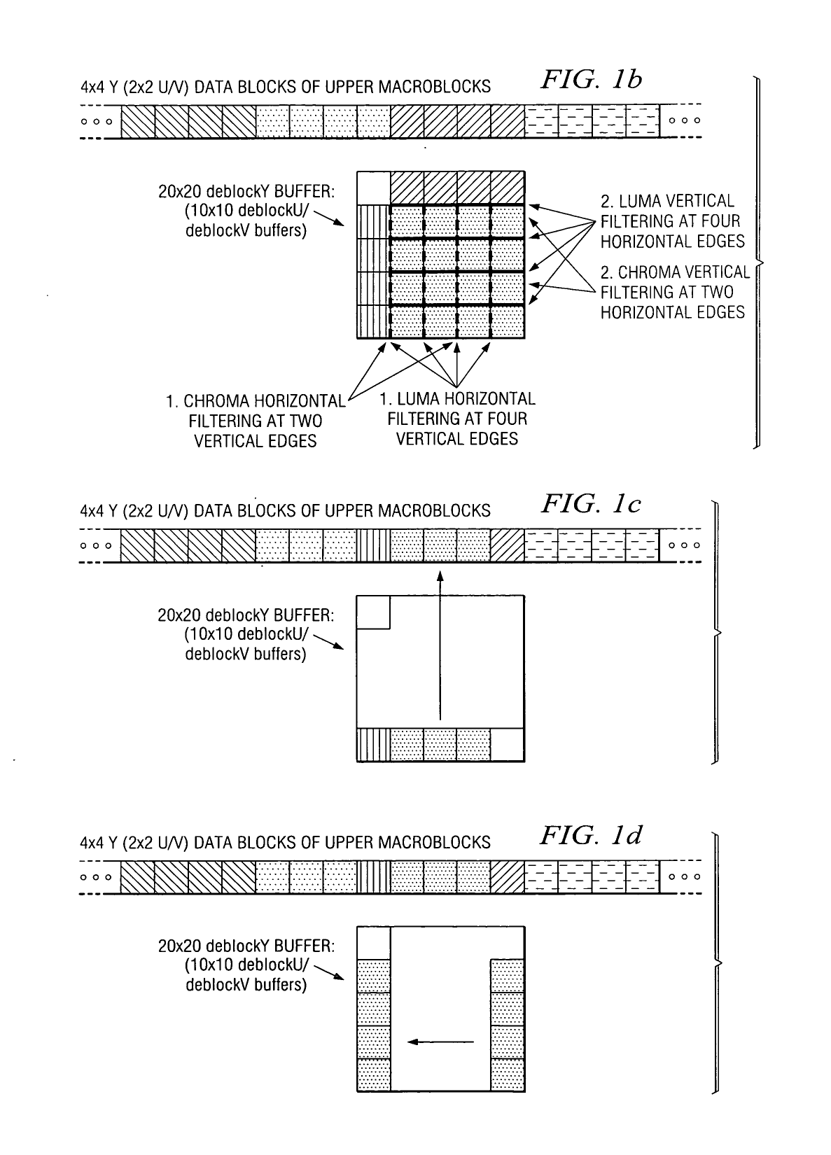

FIGS. 2a-2b illustrates the motion-compensation loop for H.264 which includes an in-loop deblocking filtering. Macroblock-based loop-filtering is done in the raster scan order in a frame. It starts with the upper left-most macroblock, going horizontally from left to right until the right edge of the frame, comes back to the left side of the frame on the second row of macroblocks, and goes from left to right horizontally again. This goes on until it reaches the last macroblock on the lower right-most corner. For example, a VGA frame (640×480 pixels) consists of 30 rows of 16×16 macroblocks with each row containing 40 macroblocks; so the raster scan has macroblocks numbered 0 to 39 from the first row, numbers 40 to 79 from the second row, and so forth. And each row of macroblocks includes 16 rows of Y (luminance) data plus 8 rows of U and 8 rows of V data.

Since the lower 4 rows of the 16 rows of Y data and lower 2 rows of each of the 8 rows of UN data of each filtered macroblock are needed for (and may be changed by) the deblocking filtering of the next row of macroblocks, the first preferred embodiment allocates a buffer of size (frame-width*4) to store the Y data (upperY) and allocates two buffers, each of size (frame-width/2*2), to store the U and V data (upperU and upperV, respectively). Thus for the VGA example, upperY would hold 640*4=2560 Y data and upperU and upperV would each hold 320*2=640 U/V data.

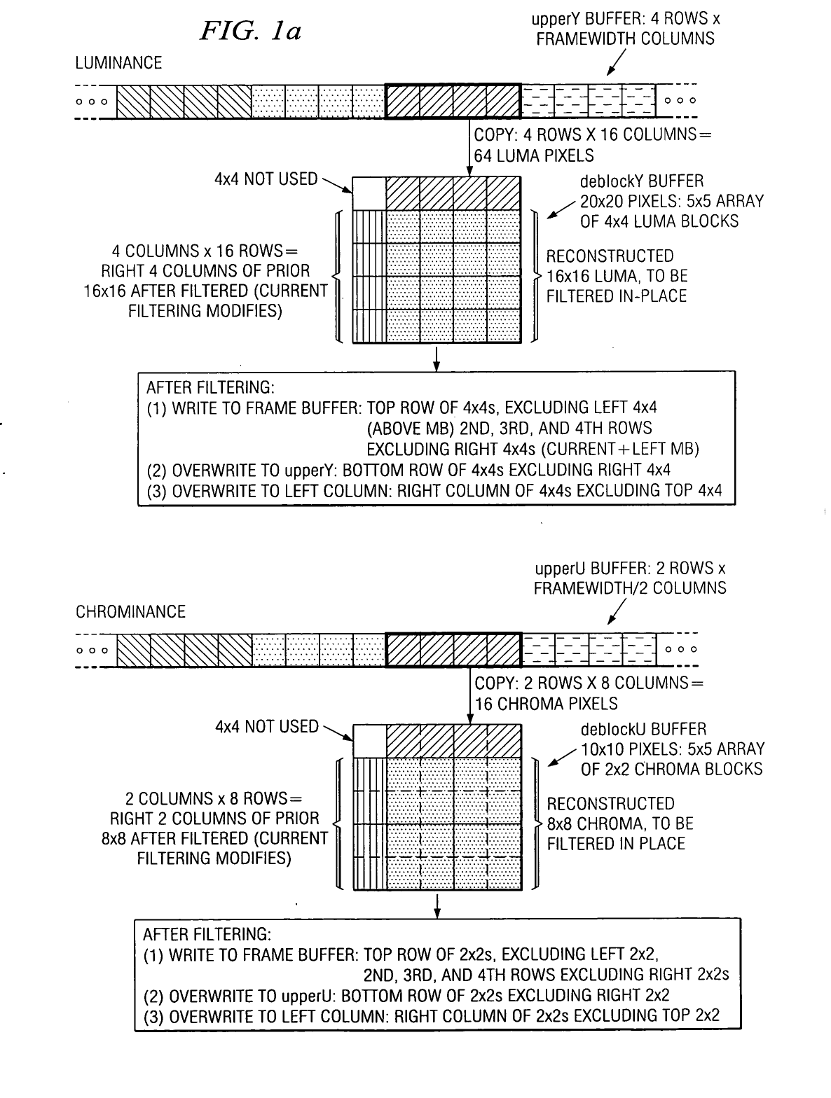

These buffers are schematically illustrated in FIGS. 1a-1e, which show the data flow during loop-filtering of a macroblock; the filtering includes the following steps.

Step 1. After macroblock reconstruction (texture data added to motion compensation prediction data in FIG. 2a), the deblockY, deblockU, and deblockV buffers contain the corresponding Y, U, and V data; that is, 16×16 luma, 8×8 U, and 8×8 V data. The reconstructed Y data is written to the 16×16 main portion of the 20×20 deblockY buffer as indicated in FIG. 1a; the U and V data are analogously written to the 8×8 main portions of the deblockU and deblockV buffers. FIG. 1a shows both the 20×20 deblockY buffer and the frame_width×4 upperY buffer. The left columns of the deblockY, deblockU, and deblockV buffers already contain the corresponding data from the right columns of the previous reconstructed and filtered macroblock; FIG. 1a shows the four columns for the deblockY buffer. Data from the upperY, upperU, and upperV buffers is copied into the top four rows of the deblockY and the top two rows of each of the deblockU and deblockV buffers, respectively; again, FIG. 1a illustrates this for the upperY and deblockY buffers.

Step 2. In-place deblocking filtering is performed using the data in the deblockY, deblockU, and deblockV buffers. In particular, first filter at the vertical block edges from left to right, and then filter at the horizontal block edges from top to bottom. For Y data in the deblockY buffer this includes eight filterings, one for each of the four vertical edges within the 5×5 array of 4×4 blocks, followed by one for each of the four horizontal edges within the 5×5 array; see FIG. 1b. Data on either side of the edges may be modified during filtering. For example, the Y data of the right column of 4×4 blocks from the immediately prior filtered 16×16 may be changed; and likewise the Y data of the bottom row of 4×4 blocks from prior (upper) row filtered 16×16 may be changed. Similarly, the U and V data filterings each includes four filterings: one for each of two vertical edges, the left and middle of the 8×8 main portion of the 10×10 buffer, followed by one for each of two horizontal edges, the top and middle of 8×8 main portion.

Step 3. Bottom four rows of the Y data and bottom two rows of the U/V data of the respective deblock buffers are copied to the corresponding upper buffers, overwriting the data it just used plus the last block of the prior macroblock's overwriting. FIG. 1c illustrates the overwriting of upperY data with the Y data from deblockY. Note that the lower right blocks in the deblock buffers need not be copied because their targets in the upper buffers will also be overwritten by the lower left blocks after the next macroblock is filtered.

Step 4. Right four columns of Y data in the deblockY buffer and right two columns of U/V data in the deblockU/deblockV buffers are shifted to the leftmost columns of the corresponding buffers to prepare for the filtering of the next macroblock; see FIG. 1d.

Step 5. Main part of the deblockY, deblockU, and deblockV buffers are filled with the corresponding reconstructed data for the next macroblock, and the top four rows of deblockY and top two rows of deblockU and deblockV buffers are filled with data of the next upper adjacent macroblock in the upperY, upperU, and upperV buffers, respectively. This is essentially a repeat of step 1. Buffers are ready for the filtering of the next macroblock as described in step 2; see FIG. 1e.

Steps 1-4 are repeated until the end of the frame, and the upper buffers and deblock buffers are cleared for the next frame.

3. Modifications

The preferred embodiments may be modified in various ways while retaining the feature of separate buffers of size to hold a macroblock plus an extra row and column for in-place deblocking filtering.

For example, only the luma could be filtered and not the chroma; the size of the buffers could be varied if the filter length or block size is varied (the unused upper left block illustrated in the deblock buffers is only heuristic), the order of filtering (left-to-right verticals then top-to-bottom horizontal) could be varied and consequent the ordering of the steps varied, and so forth.

What is claimed is:

1. A method of deblocking filtering, comprising:
(a) providing a reconstructed luma macroblock in a main portion of a luma deblock buffer;
(b) copying data from a luma row buffer to a second portion of said luma deblock buffer;
(c) filtering in place in said luma deblock buffer using data in said main portion, said second portion, and a third portion of said luma deblock buffer;
(d) copying data from a part of said main portion to said row buffer;
(e) copying data from a second part of said main portion to said third portion;
(f) repeating (a)-(e) for a second reconstructed macroblock and second data from said luma row buffer.

2. The method of claim 1, wherein:
(a) said main portion holds 16 4×4 blocks of luma data;
(b) said second portion holds 4 4×4 blocks of luma data;
(c) said third portion holds 4 4×4 blocks of luma data; and
(d) said filtering of (c) of claim 1 includes first filtering across vertical edges and second filtering across horizontal edges with said first filtering using data in said main portion and said third portion and said second filtering using data in said main portion and said second portion.

3. The method of claim 1, further comprising:
(a) providing a reconstructed chroma macroblock in a main chroma portion of a chroma deblock buffer;
(b) copying data from a chroma row buffer to a second chroma portion of said chroma deblock buffer;
(c) filtering in place in said chroma deblock buffer using data in said main chroma portion, said second chroma portion, and a third chroma portion of said chroma deblock buffer;
(d) copying data from a part of said main chroma portion to said chroma row buffer;
(e) copying data from a second part of said main chroma portion to said third chroma portion; and
(f) repeating (a)-(e) for a second reconstructed chroma macroblock and second data from said chroma row buffer.

4. A deblocking filter, comprising:
(a) a luma row buffer; and
(b) a luma deblock buffer, said luma deblock buffer operable to contain a reconstructed luma macroblock, a portion of data from said luma row buffer, and a portion of a reconstructed prior macroblock;
(c) whereby said reconstructed luma macroblock can be deblocking filtered in-place in said deblock buffer.

5. The filter of claim 4, further comprising:
(a) a chroma row buffer,
(b) a chroma deblock buffer, said chroma deblock buffer operable to contain a reconstructed chroma macroblock, a portion of data from said chroma row buffer, and a portion of a reconstructed prior chroma macroblock;
(c) wherein said a reconstructed chroma macroblock can be deblocking filtered in-place in said chroma deblock buffer.

6. A video coder, comprising:
(a) a block motion compensation loop including a block motion estimator, a block predictor, a transformer, a quantizer, an inverse quantizer, an inverse transformer, a deblocking filter, and a frame buffer; and
(b) an entropy encoder coupled to said loop;
(c) wherein said deblocking filter includes:
(i) a luma row buffer; and
(ii) a luma deblock buffer, said luma deblock buffer operable to contain a reconstructed luma macroblock, a portion of data from said luma row buffer, and a portion of a reconstructed prior macroblock;
(iii) whereby said reconstructed luma macroblock can be deblocking filtered in-place in said deblock buffer.
